(19) United States
(12) Patent Application Publication
(10) Pub. No.: US 2013/0208025 A1
(43) Pub. Date: Aug. 15, 2013

(54) DISPLAY CONTROL DEVICE, DISPLAY CONTROL METHOD, AND PROGRAM

(71) Applicant: SONY CORPORATION, (US)

(72) Inventors: Yuji NAKAHATA, Tokyo (JP); Makoto Nakagawa, Tokyo (JP)

(73) Assignee: SONY CORPORATION, Tokyo (JP)

(21) Appl. No.: 13/760,112

(22) Filed: Feb. 6, 2013

(30) Foreign Application Priority Data
Feb. 13, 2012 (JP) 2012-028551

(51) Int. Cl. G09G 5/10

(52) U.S. Cl. CPC G09G 5/10
USPC 345/690

(57) ABSTRACT

There is provided a display control device including a display control unit that performs display control of displaying an input pixel using display elements classified into high-luminance elements having luminance higher than reference luminance, which is luminance of the input pixel, and low-luminance elements having luminance lower than the reference luminance, and equalizing the number of display elements to which a driving voltage of positive polarity is applied with the number of display elements to which a driving voltage of negative polarity is applied, among the display elements belonging to the classification of the same luminance.

### BACKGROUND

The present disclosure relates to a display control device, a display control method, and a program.

For example, technologies for improving a viewing angle of a liquid crystal display panel have been known, as disclosed in Japanese Unexamined Patent Application Publication No. 2006-285238. According to the technology disclosed in Japanese Unexamined Patent Application Publication No. 2006-285238, display elements of a liquid crystal display panel are classified into high-luminance elements and low-luminance elements and an input pixel is displayed using the high-luminance elements and the low-luminance elements. On the other hand, in order to prevent image persistence of a liquid crystal display panel, there are also technologies for reversing the polarity of a driving voltage applied to each display element.

### SUMMARY

In the technology disclosed in Japanese Unexamined Patent Application Publication No. 2006-285238, however, a combination of a luminance pattern of the display elements (array of the high-luminance elements and the low-luminance elements) and a polarity pattern (array of the display elements having a driving voltage with the positive polarity (or the negative polarity)) of driving voltages has not been considered. For this reason, there has been a demand for a technology considering a combination of a luminance pattern of display elements and a polarity pattern of driving voltages.

According to an embodiment of the present disclosure, there is provided a display control device including a display control unit that performs display control of displaying an input pixel using display elements classified into high-luminance elements having luminance higher than reference luminance, which is luminance of the input pixel, and low-luminance elements having luminance lower than the reference luminance, and equalizing the number of display elements to which a driving voltage of positive polarity is applied with the number of display elements to which a driving voltage of negative polarity is applied, among the display elements belonging to the classification of the same luminance.

According to an embodiment of the present disclosure, there is provided a display control method including performing display control of displaying an input pixel using display elements classified into high-luminance elements having luminance higher than reference luminance, which is luminance of the input pixel, and low-luminance elements having luminance lower than the reference luminance, and equalizing the number of display elements to which a driving voltage of positive polarity is applied with the number of display elements to which a driving voltage of negative polarity is applied, among the display elements belonging to the classification of the same luminance.

According to an embodiment of the present disclosure, there is provided a program for causing a computer to realize a display control function of performing display control of displaying an input pixel using display elements classified into high-luminance elements having luminance higher than reference luminance, which is luminance of the input pixel, and low-luminance elements having luminance lower than the reference luminance and equalizing the number of display elements to which a driving voltage of positive polarity is applied with the number of display elements, to which a driving voltage of negative polarity is applied, among the display elements belonging to the classification of the same luminance.

According to the embodiments of the present disclosure, the display control is performed by equalizing the number of display elements to which the driving voltage of the positive polarity is applied with the number of display elements to which the driving voltage of the negative polarity is applied, among the display elements belonging to the classification of the same luminance.

According to the embodiments of the present disclosure described above, display control is performed in consideration of the combination of the luminance pattern of the display elements and the polarity pattern of the driving voltages. Accordingly, according to the embodiments of the present disclosure, occurrence of flicker or image unevenness can be prevented, since the data driving voltage can be further unified.

### BRIEF DESCRIPTION OF THE DRAWINGS

FIG. 1 is a block diagram illustrating the configuration of a display control device according to an embodiment of the present disclosure;

FIG. 2 is a flowchart illustrating the order of processes performed by the display control device;

FIG. 3 is a diagram illustrating a driving example of a liquid crystal display panel by the display control device;

FIG. 4 is a diagram illustrating a driving example of a liquid crystal display panel by the display control device;

FIG. 5 is a diagram illustrating a driving example of a liquid crystal display panel by the display control device;

FIG. 6 is a diagram illustrating a driving example of a liquid crystal display panel by the display control device;

FIG. 7 is a diagram illustrating a driving example of a liquid crystal display panel by the display control device;

FIG. 8 is a diagram illustrating a driving example of a liquid crystal display panel by the display control device;

FIG. 9 is a diagram illustrating a driving example of a liquid crystal display panel by the display control device;

FIG. 10 is a diagram illustrating a driving example of the liquid crystal display panel;

FIG. 11 is a diagram illustrating a driving example of the liquid crystal display panel;

FIG. 12 is a diagram illustrating a driving example of the liquid crystal display panel; and

FIG. 13 is a diagram illustrating a driving example of the liquid crystal display panel.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be made in the following order.

1. Configuration of Display Control Device

2. Examination of Method of Driving Liquid Crystal Display Panel

3. Various Examples of Driving of Liquid Crystal Display Panel According to Embodiment

4. Processing Order of Display Control Device

### <1. Configuration of Display Control Device>

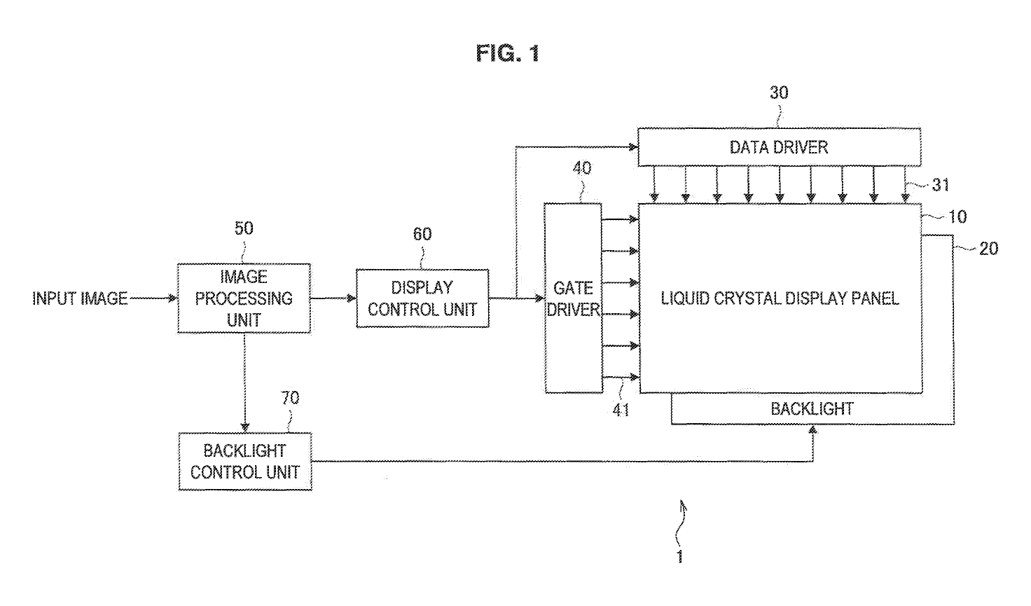

First, the configuration of a display control device 1 according to the embodiment of the present disclosure will be described with reference to FIG. 1. The display control device 1 includes a liquid crystal display panel 10, a backlight 20, a data driver 30, a gate driver 40, an image processing unit 50, a display control unit 60, and a backlight control unit 70. The image processing unit 50, the display control unit 60, and the backlight control unit 70 are realized by various hardware configurations such as a CPU, a ROM, and a RAM. That is, a program for realizing the functional block is recorded in the ROM. The CPU reads and executes the program. Thus, the image processing unit 50, the display control unit 60, and the backlight control unit 70 are realized. Further, the display control device 1 may not include the liquid crystal display panel 10. In this case, control information from the display control device 1 is configured to be supplied to an external liquid crystal display panel.

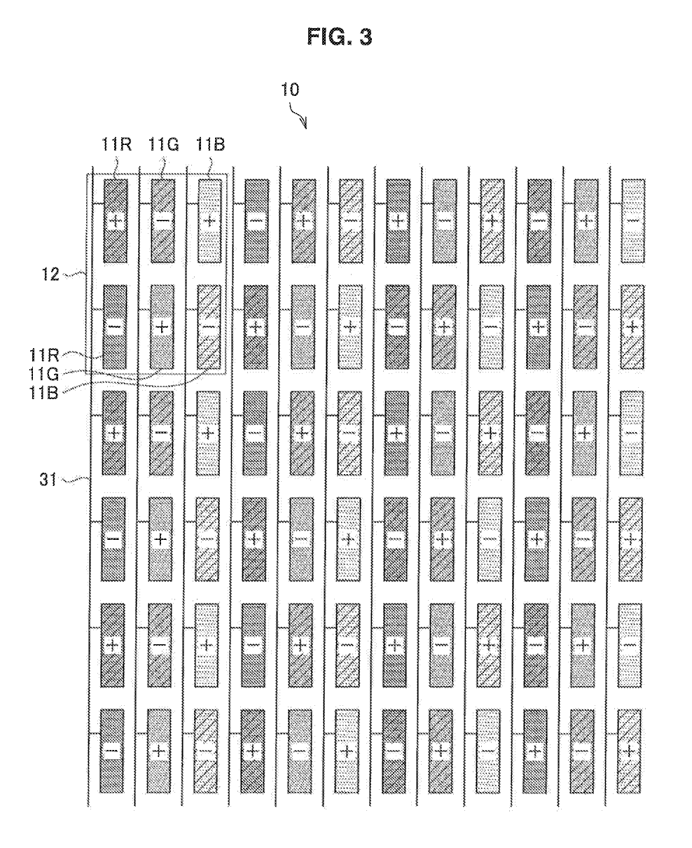

The liquid crystal display panel 10 is, for example, an active matrix type liquid crystal display panel. As shown in FIG. 3, the liquid crystal display panel 10 includes a plurality of display elements 11 arrayed in a matrix form. Each display element 11 is one of a red display element 11R that displays red, a green display element 11G that displays green, and a blue display element 11B that displays blue. The display elements 11 of the same color are arrayed in the vertical direction. The display elements 11 are arrayed in the order of red, green, and blue in the horizontal direction. In the liquid crystal display panel 10, a unit element 12 is formed by two adjacent red display elements 11R, two adjacent green display elements 11G, and two adjacent blue display elements 11B. Each unit element 12 displays each input pixel of image information.

Each display element 11 generally includes a thin film transistor (TFT), a pixel electrode, a common electrode, a liquid crystal layer, and a Cs electrode. The source, gate, and drain of the TFT are connected to a data bus line 31, a gate bus line 41, and a pixel electrode, respectively. The liquid crystal layer is disposed between the pixel electrode and the common electrode. By supplying driving voltages from a data driver 30 and a gate driver 40, a voltage is generated between the pixel electrode and the common electrode, and thus alignment of the liquid crystal layer is varied by the voltages. The Cs electrode is an electrode that retains charge of the pixel electrode.

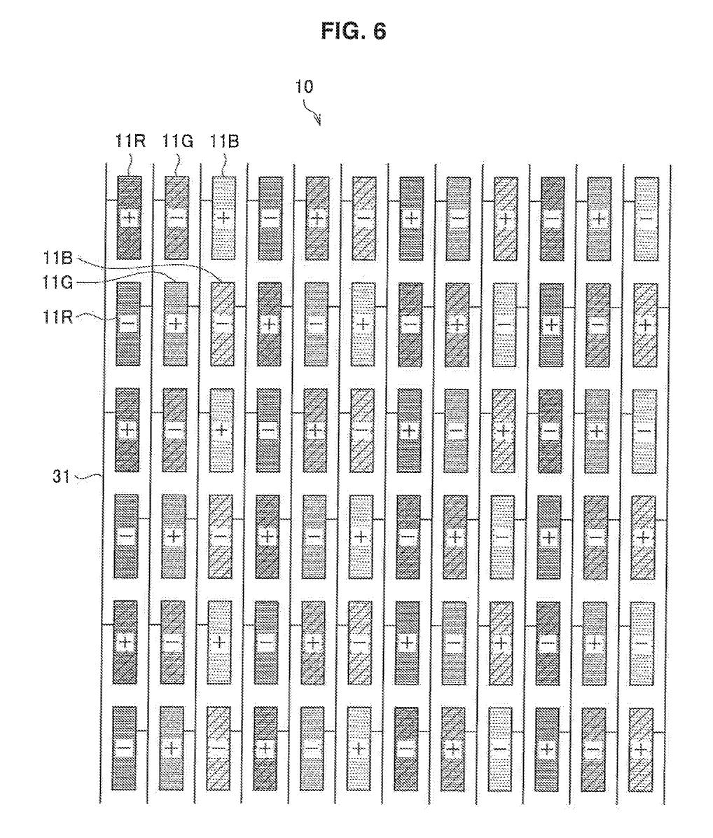

In the example shown in FIG. 3, all of the display elements 11 arrayed in the vertical direction are connected to the same data bus line 31. Such wirings are referred to as straight wirings. The wirings of the liquid crystal display panel 10 are not limited to the straight wirings, but may be, for example, cross wirings shown in FIG. 6. In the cross wirings, the display elements 11 arrayed in the vertical direction are each alternately connected to two adjacent data bus lines 31.

The backlight 20 irradiates the liquid crystal display panel 10 from the rear side. The data driver 30 supplies a driving voltage, that is, a data driving voltage, to the display elements 11 via the data bus lines 31. The gate driver 40 supplies a driving voltage, that is, a gate driving voltage, to the display elements 11 via gate bus lines 41.

The image processing unit 50 performs various kinds of preprocessing (white balance, adjustment of gray scale and chromaticity, and the like) on image information (input image) given from the outside and outputs the image information subjected to the preprocessing to the display control unit 60. The display control unit 60 displays the image information on the liquid crystal display panel 10 by controlling the data driver 30 and the gate driver 40.

### <2. Examination of Method of Driving Liquid Crystal Display Panel>

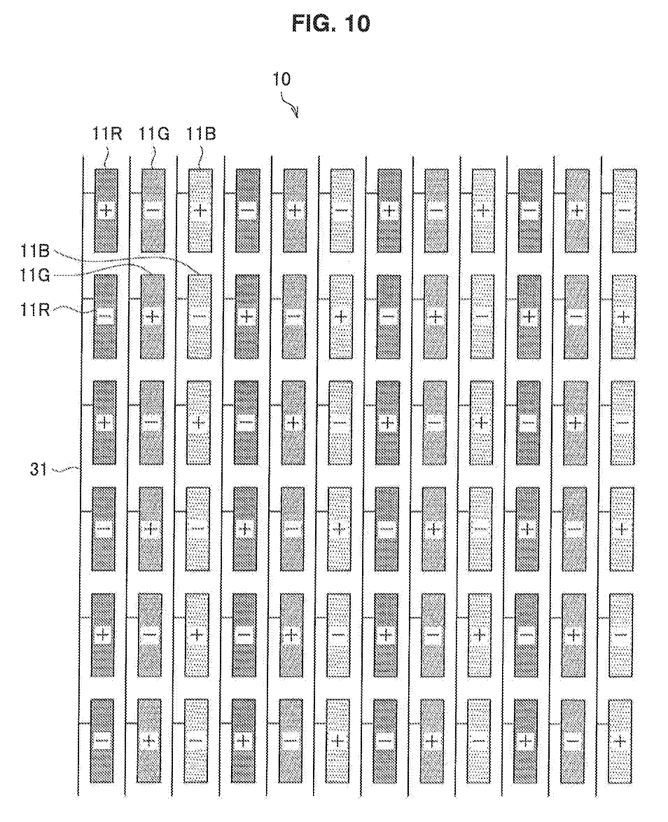

Hereinafter, a method of driving the liquid crystal display panel 10 will be examined. As the method of driving the liquid crystal display panel 10, a driving method of reversing the polarity of a data driving voltage applied to each display element 11 for each frame, a so-called frame reversing method, is known. By performing such a driving method, image persistence of the liquid crystal display panel 10 can be prevented. Further, in order to prevent occurrence of flicker or deterioration between resolutions, a dot check pattern is considered as a polarity pattern (array of the display elements 11 having a data driving voltage of a polarity pattern (positive polarity (or negative polarity))) in some cases, as shown in FIG. 10. That is, the array of the display elements 11 having the data driving voltage of the positive polarity has a check shape. The same also applies to the display elements 11 having the data driving voltage of the negative polarity. Further, the polarity of the display elements 11 (the display elements 11 in a horizontal line) connected to each gate bus line 41 is varied for each element. In FIG. 10, “+” represents the data driving voltage of the positive polarity and “−” represents the data driving voltage of the negative polarity. The same also applies to the other drawings.

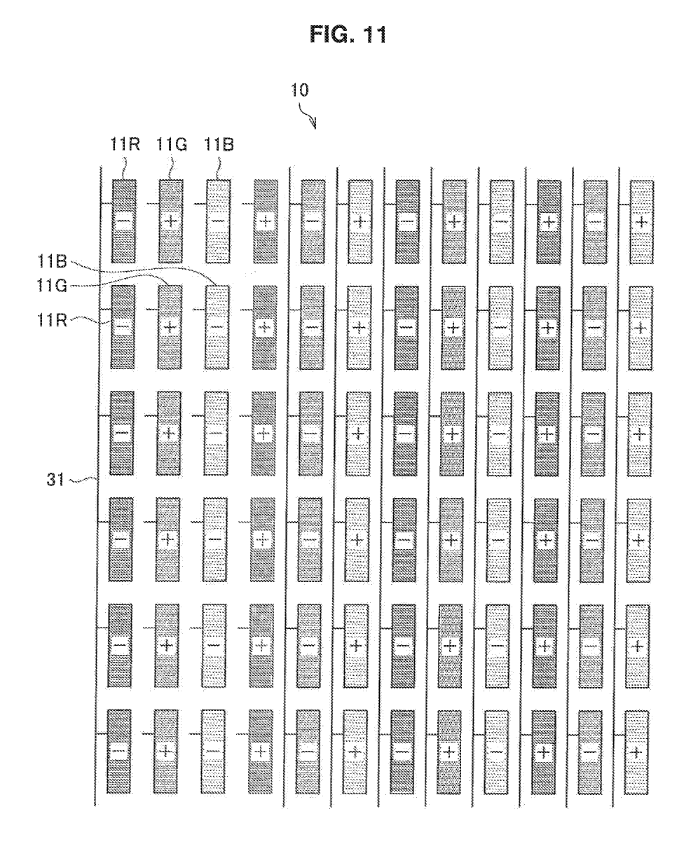

On the other hand, in the recent technologies for liquid crystal display panels, driving is performed at a high frequency such as 240 Hz in runny cases to improve the resolution of a moving image. To realize the driving, it is necessary to maintain a high charging rate of a TFT. In order to resolve the problem, a method of reducing the influence of slowdown of the data driving voltage caused due to the impedance of the data bus line 31 by applying a driving voltage of the same polarity to one data bus line 31 has frequently been used. In this case, as shown in FIG. 11, a polarity pattern becomes a vertical line reverse pattern in many cases. That is, the display elements 11 connected to one data bus line 31 have the data driving voltage of the same polarity and the display elements 11 of the adjacent data bus lines 31 have the data driving voltages of mutually different polarities.

On the other hand, to improve a viewing angle of the liquid crystal display panel 10, a driving method of displaying one pixel (input pixel) of image information using the plurality of display elements 11 is also known. In this driving method, the display elements 11 are classified into high-luminance elements having luminance higher than the luminance of the input pixel, that is, reference luminance, and low-luminance elements having luminance lower than the reference luminance. The input pixel is displayed using the high-luminance elements and the low-luminance elements.

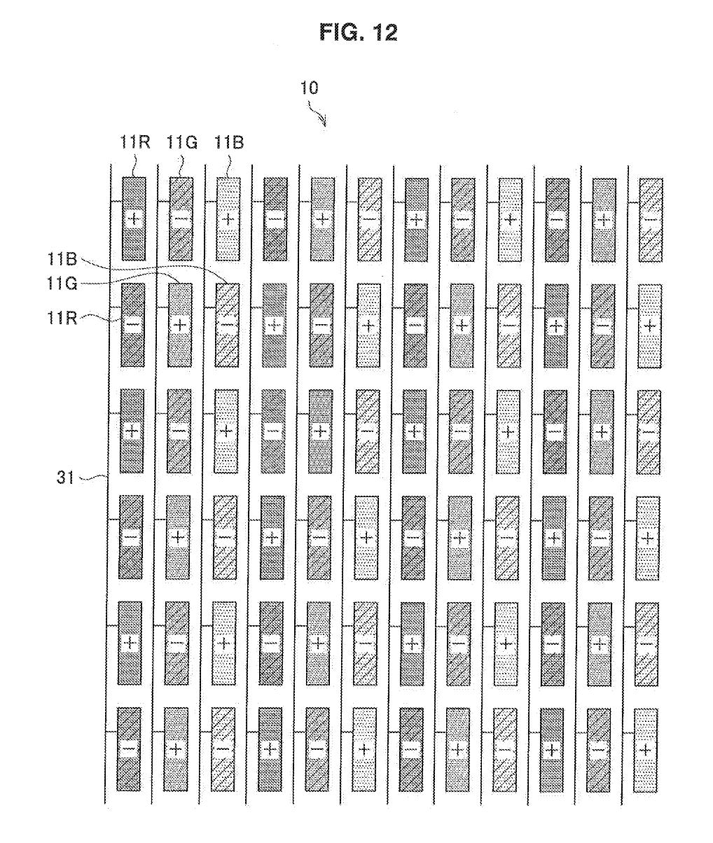

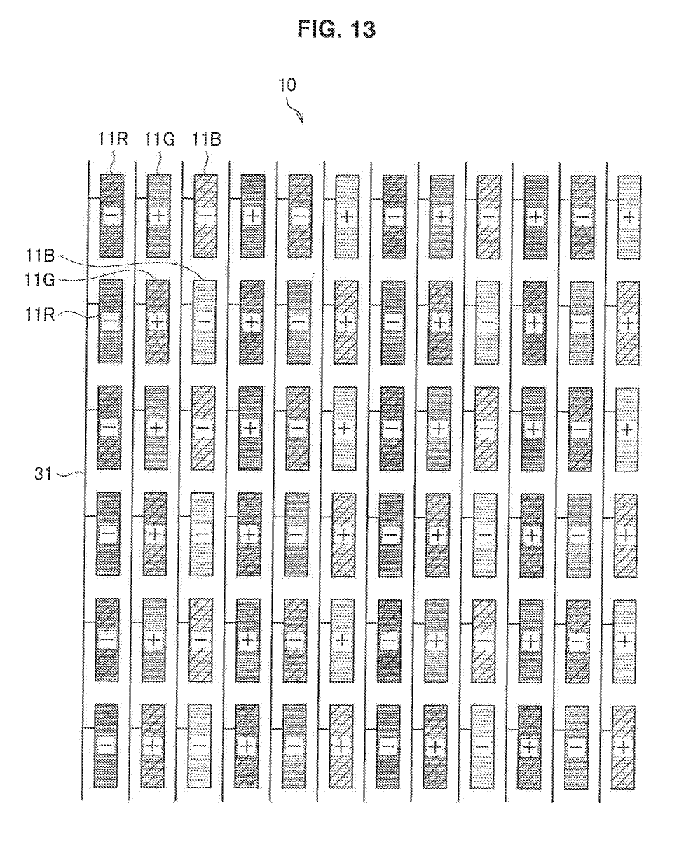

In this driving method, a luminance pattern (array of the high-luminance elements and the low-luminance elements) may be as minute as possible to prevent deterioration in resolution or occurrence of flicker. Dot check patterns shown in FIGS. 12 and 13 are known as the luminance pattern. That is, the array of the high-luminance elements has a check pattern. The same also applies to array of the low-luminance elements. Further, the luminance classification of the display elements 11 connected to each gate bus line 41 is varied for each element. In FIGS. 12 and 13, the high-luminance elements and the low-luminance elements are distinguished from each other depending on presence or absence of hatching. That is, an element drawn with hatching is a low-luminance element and an element drawn with no hatching is a high-luminance element. The same also applies to the other drawings.

In this driving method, however, an image quality may deteriorate due to interference with the polarity pattern. For example, as shown in FIG. 12, when both the polarity pattern and the luminance are the dot check pattern, all of the high-luminance elements have the data driving voltage of the positive polarity. Therefore, the absolute value of the data driving voltage of the positive polarity is larger than the absolute value of the data driving voltage of the negative polarity. For this reason, since the Cs voltage and the common voltage are drawn toward the positive polarity, irregularity may occur in the data driving voltage and flicker or image unevenness may occur due to a difference in impedance. The same also applies to FIG. 13.

Accordingly, the display control device 1 according to this embodiment prevents the occurrence of the flicker or the image unevenness by further unifying the data driving voltage. That is, the display control unit 60 first classifies the red display element 11R forming the unit element 12 as one of the high-luminance element and the low-luminance element. Here, the high-luminance element is an element that has luminance higher than reference luminance which is an R value (luminance of red) of an input pixel (pixel of image information). The low-luminance element is an element that has luminance lower than the reference luminance. Here, the display control unit 60 distributes the high-luminance elements and the low-luminance elements so that a pattern of the high-luminance elements and the low-luminance elements is as minute as possible. This is because the resolution of the liquid crystal display panel 10 is prevented from being lowered, as the pattern of the high-luminance elements and the low-luminance elements is as minute as possible.

Then, the display control unit 60 determines the luminances of the high-luminance element and the low-luminance element based on the R value (the luminance of red) of the input pixel. That is, the display control unit 60 displays the input pixel using the high-luminance elements and the low-luminance elements. Accordingly, the improvement in the viewing angle is achieved. Further, since the display control unit 60 stores a table indicating a correspondence relation between the R value of the input pixel and the luminances of the high-luminance element and the low-luminance element, the display control unit 60 determines the luminances of the high-luminance element and the low-luminance element based on the table. When the luminance of the input pixel is the maximum value of the luminance which can be displayed by the liquid crystal display panel 10, both the luminances of the high-luminance element and the low-luminance element coincide with the maximum value.

The display control unit 60 determines the polarity of the data driving voltage so that the number of red display elements 11R to which the data driving voltage of the positive polarity is applied is equalized with the number of red display elements 11R to which the data driving voltage of the negative polarity is applied, among the red display elements 11R belonging to the same luminance classification. The display control unit 60 performs the same processing even on the green and blue display elements 11. Here, the polarity of the data driving voltage applied to each display element 11 may be reversed for each frame for periodically). For example, when a driving voltage applied to a given display element becomes the positive polarity in a given frame, the driving voltage applied to the display element may become the negative polarity in the subsequent frame.

### <3. Various Examples of Driving of Liquid Crystal Display Panel According to Embodiment>

Next, a specific driving example of this embodiment will be described. FIGS. 3 to 9 are diagrams illustrating a driving example of this embodiment. In FIG. 3, a polarity pattern is a dot check pattern and a luminance pattern is a horizontal two-dot check pattern. That is, the luminance classification of the display elements 11 connected to the gate bus lines 41 is varied for every two elements. The array of the high-luminance elements and the low-luminance elements has a check shape.

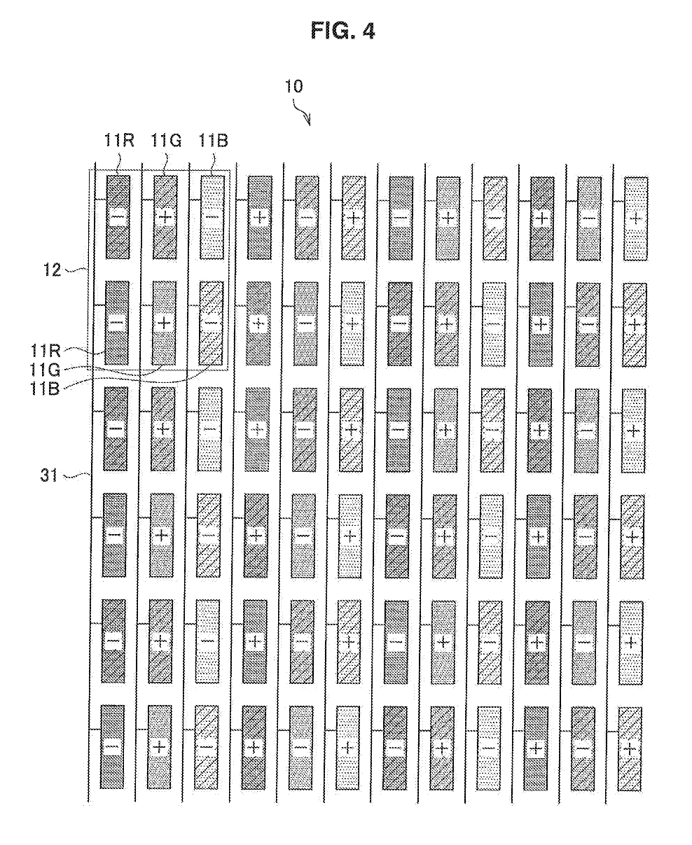

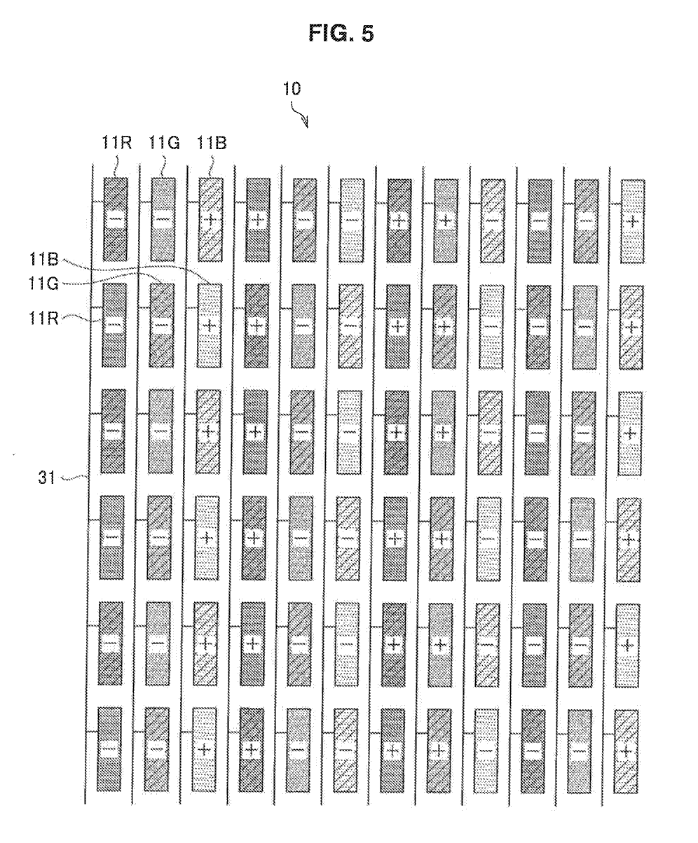

On the other hand, in FIG. 4, the polarity pattern is a vertical line reverse pattern and the luminance pattern is a horizontal two-dot check pattern. In FIG. 5, the polarity pattern is a vertical two-line reverse pattern and the luminance pattern is a dot check pattern. That is, the polarity of the data driving voltage is reversed for every two data bus lines. In a driving example of FIG. 5, the deterioration in the resolution can be prevented, since the luminance pattern is more minute than that of the driving example of FIG. 4. However, since the right and left display elements 11 of a given display element 11 have the data driving voltages of mutually different polarities, the display control unit 60 may perform correction according to a difference between the polarities.

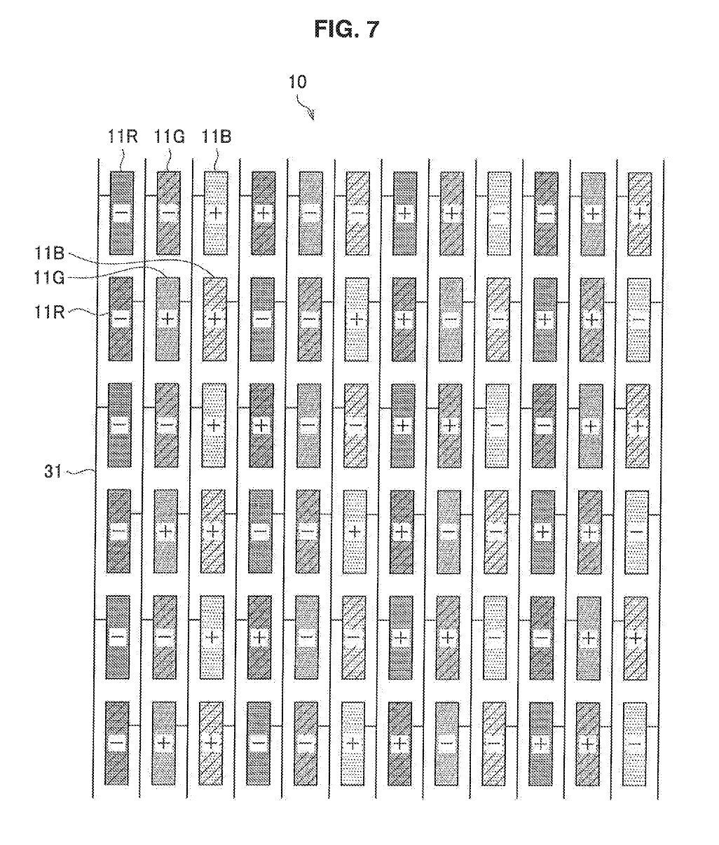

In FIG. 6, the polarity pattern is a dot check pattern, the luminance pattern is a horizontal two-dot check pattern, and the wirings of the display elements 11 are cross wirings. In FIG. 7, the polarity pattern is a vertical two-line reverse pattern, the luminance pattern is a dot check pattern, and the wirings of the display elements 11 are cross wirings.

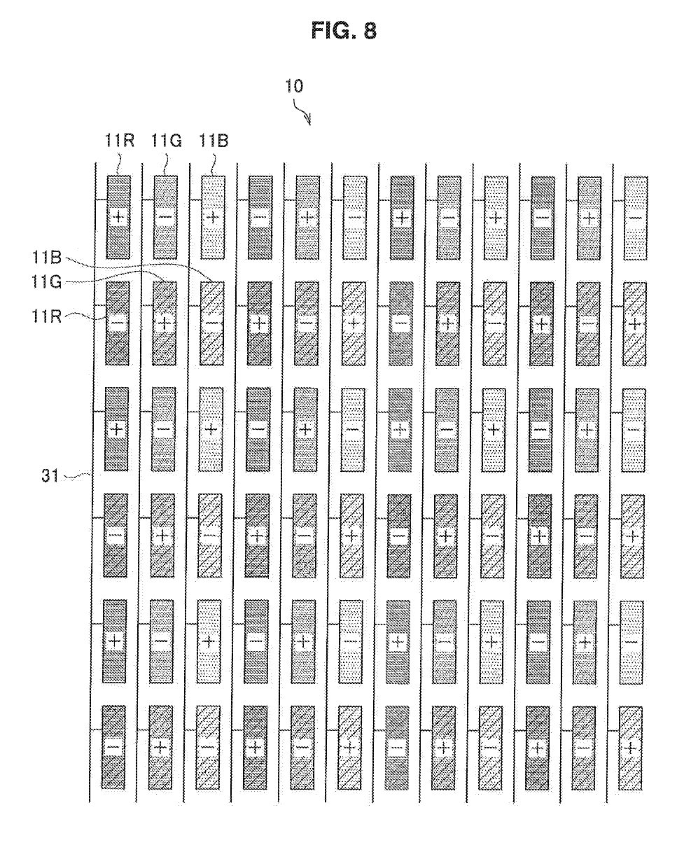

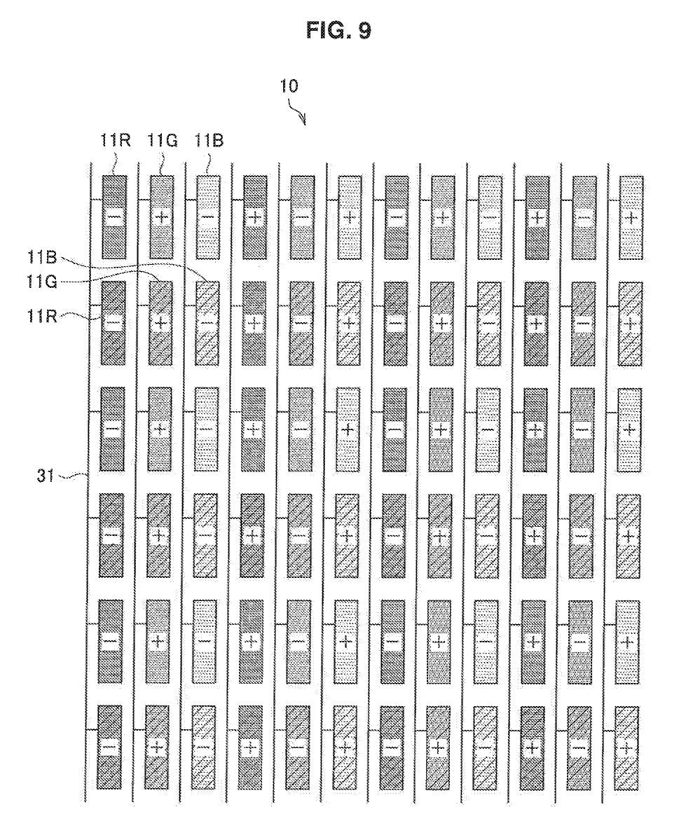

On the other hand, in FIG. 8, the polarity pattern is a dot check pattern and the luminance pattern is a horizontal line pattern. That is, the display elements 11 connected to one gate bus line 41 have the luminance of the same classification and the display elements 11 of the adjacent gate bus lines 41 have the luminance of the different classification. In FIG. 9, the polarity pattern is a vertical line reverse pattern and the luminance pattern is a horizontal line pattern.

Even in the driving examples of FIGS. 3 to 9, the number of display elements 11 to which the data driving voltage of the positive polarity is applied is equalized with the number of display elements 11 to which the data driving voltage of the negative polarity is applied, among the display elements 11 belonging to the classification of the same luminance. For example, the number of high-luminance elements having the data driving voltage of the positive polarity is equal to the number of high-luminance elements having the data driving voltage of the negative polarity. That is, the display control unit 60 controls the liquid crystal display panel 10 in consideration of a combination of the luminance pattern of the display elements 11 and the polarity pattern of the data driving voltages. Thus, the display control unit 60 can prevent the occurrence of flicker or image unevenness, since the display control unit 60 can further unify the data driving voltage.

Even in the driving examples of FIGS. 8 and 9, the data driving voltage can be further unified. In the driving examples, however, the resolution in the vertical line direction, that is, the resolution in the direction of the data bus line 31, is lowered. Accordingly, the luminance pattern is preferably a more minute pattern, specifically, the patterns shown in FIGS. 3 to 7. In the examples shown in FIGS. 3 to 7, at least the high-luminance elements and the low-luminance elements are arrayed in the same gate bus line 41. In FIGS. 3, 4, and 6, the classification of the luminance in the same gate bus line 41 is varied for every two elements. In the examples, the resolution is prevented from being lowered.

### <4. Processing Order of Display Control Device>

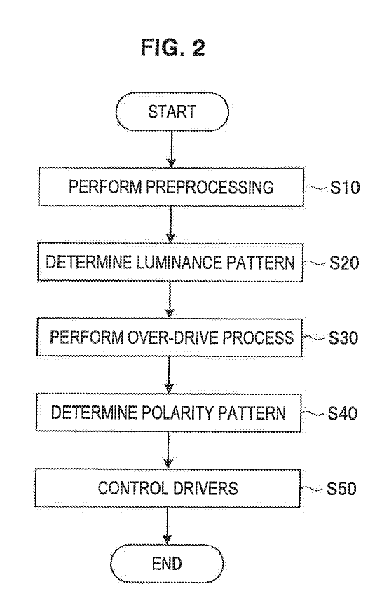

Next, the order of processes performed by the display control device 1 will be described with reference to the flowchart shown in FIG. 2. In step S10, the image processing unit 50 acquires the image information, performs various kinds of preprocessing (white balance, adjustment of gray scales and chromaticity, and the like) on the image information, and outputs the image information subjected to the preprocessing to the display control unit 60 and the backlight control unit 70.

In step S20, the display control unit 60 determines the luminance pattern of each display element 11. The method of determining the luminance pattern has been described above. That is, the display control unit 60 first classifies the red display element 11R forming the unit element 12 as one of the high-luminance element and the low-luminance element. Then, the display control unit 60 determines the luminances of the high-luminance element and the low-luminance element based on the R value of the input pixel. Thus, the display control unit 60 determines the luminance pattern of the red display elements 11R. The display control unit 60 also determines the luminance pattern of the green display elements 11G and the blue display elements 11B.

In step S30, the display control unit 60 performs an over-drive process. The over-drive process is a process of increasing the data driving voltage to be applied to each display element 11, for example, when the image information is moving image information.

In step S40, the display control unit 60 determines the polarity pattern of the data driving voltages. The method of determining the polarity pattern has been described above. That is, the display control unit 60 determines the polarity of the data driving voltage applied to each red display element 11R so that the number of red display elements 11R to which the data driving voltage of the positive polarity is applied is equalized with the number of red display elements 11R to which the data diving voltage of the negative polarity is applied, among the red display elements 11R belonging to the classification of the same luminance. The display control unit 60 also performs the same process on the green display elements 11G and the blue display elements 11B.

In step S50, the display control unit 60 drives the liquid crystal display panel 10 using the determined luminance pattern and the determined polarity pattern. Specifically, the display control unit 60 outputs control information indicating the luminance pattern and the polarity pattern to the data driver 30 and the gate driver 40, and then the data driver 30 and the gate driver 40 drive the display elements 11 based on the given control information. The backlight control unit 70 turns on and off the backlight 20 in synchronization with the driving of the liquid crystal display panel 10. Thus, the liquid crystal display panel 10 displays the image information. Thereafter, the display control device 1 ends the process.

According to this embodiment, as described above, the display control device 1 performs the display control of equalizing the number of display elements 11 to which the data driving voltage of the positive polarity is applied with the number of display elements 11 to which the data driving voltage of the negative polarity is applied, among the display elements 11 belonging to the classification of the same luminance. That is, the display control device 1 controls the liquid crystal display panel 10 in consideration of the combination of the luminance pattern of the display elements 11 and the polarity pattern of the data driving voltages. Thus, the display control device 1 can prevent occurrence of flicker or image unevenness, since the display control device 1 can further unify the data driving voltage.

The display control device 1 can further unify the data driving voltage, since the display control device 1 performs the display control for each color of the display element 11.

The display control device 1 can prevent the deterioration in the resolution, since the high-luminance elements and the low-luminance elements are arrayed in the same gate bus line 41.

The display control device 1 can reliably prevent the deterioration in the resolution, since display control device 1 varies the classification of the luminance in the same gate bus line 41 for every two elements.

The display control device 1 can set the luminance pattern to be more minute, since the display control device 1 reverses the polarity of the data driving voltage for every two data bus lines.

It should be understood by those skilled in the art that various modifications, combinations, sub-combinations and alterations may occur depending on design requirements and other factors insofar as they are within the scope of the appended claims or the equivalents thereof.

For example, the display element 11 may be further separated into a plurality of sub-display elements and the luminance of the display element 11 may be displayed according to a combination of the sub-display elements. Such a process is also called a halftone process.

The present disclosure contains subject matter related to that disclosed in Japanese Priority Patent Application JP 2012-028551 filed in the Japan Patent Office on Feb. 13, 20xx, the entire content of which is hereby incorporated by reference,

(1) A display control device including:

a display control unit that performs display control of displaying an input pixel using display elements classified into high-luminance elements having luminance higher than reference luminance, which is luminance of the input pixel, and low-luminance elements having luminance lower than the reference luminance, and equalizing the number of display elements to which a driving voltage of positive polarity is applied with the number of display elements to which a driving voltage of negative polarity is applied, among the display elements belonging to the classification of the same luminance.

(2) The display control device according to (1), wherein the display control unit performs the display control for each color of the display elements.
(3) The display control device according to (1) or (2), wherein the display control unit arranges the high-luminance elements and the low-luminance elements in the same line.
(4) The display control device according to (3), wherein the display control unit changes the classification of the luminance for every two elements in the same line.
(5) The display control device according to any one of (1) to (4), wherein the display control unit reverses the polarity of the driving voltage for every two lines.
(6) A display control method including:

performing display control of displaying an input pixel using display elements classified into high-luminance elements having luminance higher than reference luminance, which is luminance of the input pixel, and low-luminance elements having luminance lower than the reference luminance, and equalizing the number of display elements to which a driving voltage of positive polarity is applied with the number of display elements to which a driving voltage of negative polarity is applied, among the display elements belonging to the classification of the same luminance.

(7) A program for causing a computer to realize a display control function of performing display control of displaying an input pixel using display elements classified into high-luminance elements having luminance higher than reference luminance, which is luminance of the input pixel, and low-luminance elements having luminance lower than the reference luminance and equalizing the number of display elements to which a driving voltage of positive polarity is applied with the number of display elements, to which a driving voltage of negative polarity is applied, among the display elements belonging to the classification of the same luminance.

What is claimed is:

1. A display control device comprising:
a display control unit that performs display control of displaying an input pixel using display elements classified into high-luminance elements having luminance higher than reference luminance, which is luminance of the input pixel, and low-luminance elements having luminance lower than the reference luminance, and equalizing the number of display elements to which a driving voltage of positive polarity is applied with the number of display elements to which a driving voltage of negative polarity is applied, among the display elements belonging to the classification of the same luminance.

2. The display control device according to claim 1, wherein the display control unit performs the display control for each color of the display elements.

3. The display control device according to claim 1, wherein the display control unit arranges the high-luminance elements and the low-luminance elements in the same line.

4. The display control device according to claim 3, wherein the display control unit changes the classification of the luminance for every two elements in the same line.

5. The display control device according to claim 1, wherein the display control unit reverses the polarity of the driving voltage for every two lines.

6. A display control method comprising:
performing display control of displaying an input pixel using display elements classified into high-luminance elements having luminance higher than reference luminance, which is luminance of the input pixel, and low-luminance elements having luminance lower than the reference luminance, and equalizing the number of display elements to which a driving voltage of positive polarity is applied with the number of display elements to which a driving voltage of negative polarity is applied, among the display elements belonging to the classification of the same luminance.

7. A program for causing a computer to realize a display control function of performing display control of displaying an input pixel using display elements classified into high-luminance elements having luminance higher than reference luminance, which is luminance of the input pixel, and low-luminance elements having luminance lower than the reference luminance and equalizing the number of display elements to which a driving voltage of positive polarity is applied with the number of display elements, to which a driving voltage of negative polarity is applied, among the display elements belonging to the classification of the same luminance.
